(19) United States
(12) Patent Application Publication
(10) Pub. No.: US 2015/0109935 A1
(43) Pub. Date: Apr. 23, 2015

(54) SYSTEM AND METHOD FOR MONITORING MULTIPLE VIDEO CONFERENCES

(71) Applicant: NextGen Reporting, Wayne, PA (US)

(72) Inventors: David Noteware, Bryn Mawr, PA (US); Jonathan De Jong, East Norriton, PA (US)

(73) Assignee: NextGen Reporting, Wayne, PA (US)

(21) Appl. No.: 14/058,667

(22) Filed: Oct. 21, 2013

(51) Int. Cl. H04L 12/26; H04N 7/15

(52) U.S. Cl. CPC H04L 43/50; H04N 7/15
USPC 370/241

(57) ABSTRACT

A system and method for monitoring a plurality of video conferences are provided. The method employs at least first and second monitors, a speaker, a microphone, and a plurality of computers. The method includes: (a) joining each of the plurality of video conferences on a different one of the plurality of computers; (b) providing a monitoring environment of all of the plurality of video conferences, including (1) first displaying, simultaneously in a mosaic using at least the first monitor, video feed from the plurality of computers and (2) outputting a combined audio feed of the plurality of computers; (c) interacting with one of the plurality of video conferences, including (1) selecting one of the plurality of computers for connection to at least the microphone and the second monitor, (2) sending an audio feed from the microphone to the selected one of the plurality of computers; and (3) second displaying, on the second monitor, a video feed of the video conference as provided by the selected one of the plurality computers; wherein the method is configured to perform the monitoring and the interacting at the same time, such that all video conferences can be monitored while one of the video conferences is interacted with.

### FIELD OF THE INVENTION

Embodiments of the instant application relate to video conferencing. More specifically, embodiments of the instant application relate to monitoring and maintenance of multiple simultaneous video conferences.

### BACKGROUND

Video conferencing has emerged in recent years as a viable alternative or complement to face-to-face meetings. The basic components needed for a participant to a video conference is a computer that can connect to a network (e.g., the Internet), a video camera and microphone for the video and audio input of the participant, and a display and speaker to receive video and audio of the remote participants. Video conferencing software may be resident on the computer and/or the network. The computer includes standard computing components, including memory, processor, modem, display, keyboard, mouse, etc.

Video conferencing services vary in robustness, and typically in relation to the cost of the service. For example, free or low cost services provide images of lower quality, the connections can be unstable, the maximum number of participants can be low, and there is no real time monitoring of the video conference by live technical support. For those requiring heavy-duty and reliable video conferencing services or complete native solutions, there are more robust options with superior equipment, more stable connections, large numbers of possible participants, recording options and live monitoring by technical support to respond to technical issues in real time.

Live monitoring of video conferences with real time technical support is a particular challenge. To provide live monitoring, a technician must join the conference call as a participant. Preferably in a silent/muted non-visible role during the call, the technician will monitor the technical aspects of the call and respond in real time to the same. For example, if the technician sees a drop off in connectivity, the technician might transfer the conference onto another server. In another example, if a participant to the conference states that they need help, the technician hears the request and can converse with the requestor in real time to identify and respond to the concern.

By nature of the monitoring role, the technician must monitor the entire conference and be available as needed. However, such monitoring does not require all of the attention of the technician. It is therefore possible for the technician to engage in other activities during the monitoring, including monitoring multiple conferences at once.

The architecture of the equipment supporting the technician is a limiting factor on how many video conferences a technician can support. Specifically, it is known that a single computer can only maintain a single video conference at a time; attempting two conferences on the same computer would cause the conferences to interfere with each other. Thus, the technician must have a completely different computer setup for each video conference.

For example, and referring now to FIG. 1, a technician monitoring two video conferences simultaneously would need two independent computer setups 102 on their left and right, with their monitors disposed near each in the center so the technician could see both at the same time.

Both setups 102 include the standard components of a computer setup for video conferencing, including computer, display, speakers (built in, separate or headphone, not shown), microphone (built in, separate, or headset, not shown), a video camera, and control equipment (e.g., keyboard and mouse).

When a technician intervenes in one of the video conferences, they have to physically position themselves at the first setup to interact with that particular video conference. If intervention were needed at the other video conference, the technician would have to physically relocate to the other setup.

As a practical matter, the environment limits each technician to a maximum of two video conferences. This can be seen visually with respect to FIG. 2, which shows three computer setups 102 for three separate video conferences. The physical movements and control requirements to move amongst three different stations is believed to be beyond what a single technician can tolerate for any extended period of time.

It is accordingly an object of embodiments of the application to provide a system and method for monitoring video conferences that reduces the effort required to monitor two or more conferences.

It is accordingly an object of embodiments of the application to provide a system and method for monitoring video conferences that allows a technician to simultaneously monitor three or more conferences.

### SUMMARY OF THE INVENTION

According to an embodiment of the invention, a method for monitoring a plurality of video conferences is provided. The method employs at least first and second monitors, a speaker, a microphone, and a plurality of computers. The method includes: (a) joining each of the plurality of video conferences on a different one of the plurality of computers; (b) providing a monitoring environment of all of the plurality of video conferences, including (1) first displaying, simultaneously in a mosaic using at least the first monitor, video feed from the plurality of computers and (2) outputting a combined audio feed of the plurality of computers; (c) interacting with one of the plurality of video conferences, including (1) selecting one of the plurality of computers for connection to at least the microphone and the second monitor, (2) sending an audio feed from the microphone to the selected one of the plurality of computers; and (3) second displaying, on the second monitor, a video feed of the video conference as provided by the selected one of the plurality computers; wherein the method is configured to perform the monitoring and the interacting at the same time, such that all video conferences can be monitored while one of the video conferences is interacted with.

The above embodiment may have various features. The first displaying may include receiving individual video feed of each of the plurality of computers, generating, from the received individual video feeds, a single video signal representing a mosaic of the received individual video feeds, and displaying the signal video signal. The generating may include processing by a multi-viewer device. The outputting the combined audio feed may include receiving the audio of the plurality of conferences, and combining the audio of the plurality of conferences into the combined audio feed. The receiving and combining may be performed by a mixing device. The selecting may prevent the non-selected ones of the plurality of computers from interacting with the microphone and second monitor. The selecting may be performed by a switching device, the switching device connecting the microphone and second monitor to a plurality of selectable paths to the plurality of computers; the selecting further including selecting one of the plurality of paths, wherein the switching device connects the selected one of the plurality of computers to the microphone and second monitor, and wherein the switching device disconnects the non-selected ones of the plurality of computers from the microphone and second monitor. The selecting may permit, through the speaker and the second monitor, participation in the video conference supported by the selecting one of the plurality of computers, and precludes participation in the non-selected video conferences. The method may employ control equipment, wherein the selecting includes selecting one of the plurality of computers for connection to the control equipment.

According to another embodiment of the invention, a method for monitoring a plurality of video conferences is provided. The method includes maintaining a plurality of video conferences, first displaying, in a common viewing area, a mosaic of video feed of plurality of video conferences, outputting an audio feed of the plurality of video conferences, selecting an individual one of the plurality of video conferences, second displaying, in a separate area from the first displaying, video feed of the selected video conference, and receiving audio input for the selected video conference to the exclusion of non-selected video conferences, wherein the first displaying and outputting allow passive monitoring of plurality of video conferences, and the second playing and receiving allow active interaction with the selected video conference.

The above embodiment of the invention may include various features. The method may include receiving control commands for the selected video conference to the exclusion of the non-selected video conferences. The method may be configured to simultaneously perform the maintaining, first displaying, outputting, second displaying, and receiving. The method may include changing to a different selected video conference, wherein in response thereto the second displaying and the receiving transition to the different selected video conference. The selecting may be performed by a switching device that selectively connects a monitor and a microphone to a computer that supports the selected video conference, where the monitor supports the second displaying and the microphone supports the receiving. The selecting may permit active participation in the selected video conference, and preclude active participation in the non-selected video conferences. The selecting preferably does not affect the outputting.

According to yet another embodiment of the invention, a video conference monitoring apparatus is provided. A plurality of computers each supports an independent video conference. An audio mixing device connected to the plurality of computers is configured to combine audio feed of the plurality of computers into a combined audio feed. A multi-viewer device connected to the plurality of computers is configured to combine the video feed of the plurality of computers into a mosaic on a first monitor. A microphone is configured to send audio. A second monitor is provided. A switching device is configured to selectively connect the microphone and the second monitor to a selected one of the plurality of computers. The video conferences are configured to be passively monitored by the mosaic on the first monitor and the combined audio feed. A selected video conference can be actively participated in by setting the switching device to the computer that supports the selected video conference.

The above embodiment may have various features. The switching device may be a KVM switch. Audio feed from the microphone may pass through the switching device and be subject to its selection, and the audio feed from the plurality of computers may bypass the switching device so as not to be effected by the switching device.

### BRIEF DESCRIPTION OF THE DRAWINGS

Various embodiments in accordance with the present disclosure will be described with reference to the drawings, in which:

FIG. 1 illustrates a prior art setup for monitoring two video conferences.

FIG. 2 illustrates a prior art setup for monitoring three video conferences.

FIG. 3 illustrates an embodiment of the invention from the perspective of a technician.

FIG. 4 illustrates a schematic of the embodiment of FIG. 3.

FIGS. 5-8, 10 and 11 illustrate subsections of the embodiment of FIG. 4.

FIG. 9 illustrates functionality of a switching device according to an embodiment of the invention.

FIG. 12 illustrates another embodiment of the invention.

FIG. 13 illustrates another embodiment of the invention.

FIG. 14 illustrates another embodiment of the invention.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

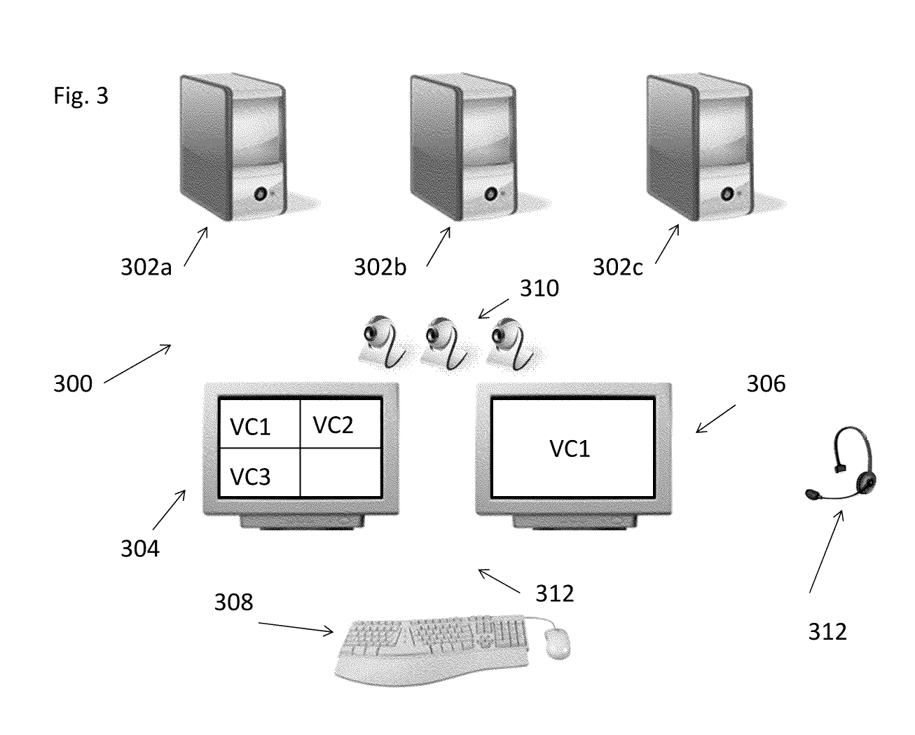

Referring now to FIG. 3, an embodiment 300 of the invention is shown from a conceptual level, and with connections and supporting components not shown (although discussed below). The embodiment of FIG. 3 is discussed with respect to three video conferences VC1, VC2 and VC3 at the same time, although it is to be understood that the invention is not limited to any specific number.

Each video conference will require its own dedicated computer 302; for the three video conferences VC1-VC3 in FIG. 3, these are shown as computers 302a (VC1), 302b (VC2), and 302c (VC3). These video conferences will preferably be effectuated in the known manner. The embodiments of the invention do not alter the methodology in which the video conferences are effectuated, and the embodiments are not limited to any particular video conference application or methodology.

Embodiment 300 includes two monitors 304 and 306 to monitor the video conferences. First monitor 304 displays a mosaic of the video feeds of all available video conferences, in this case VC1-VC3. The mosaic allows the technician to monitor the video of all the conferences simultaneously by just focusing attention on first monitor 304, without having to divide attention between different individual monitors for individual conferences.

As discussed in more detail below, the technician can elect to interact with one of the video conferences. Second monitor 306 displays the video feed of the particular video conference that the technician elects to interact with, shown as video conference VC 1 in FIG. 3.

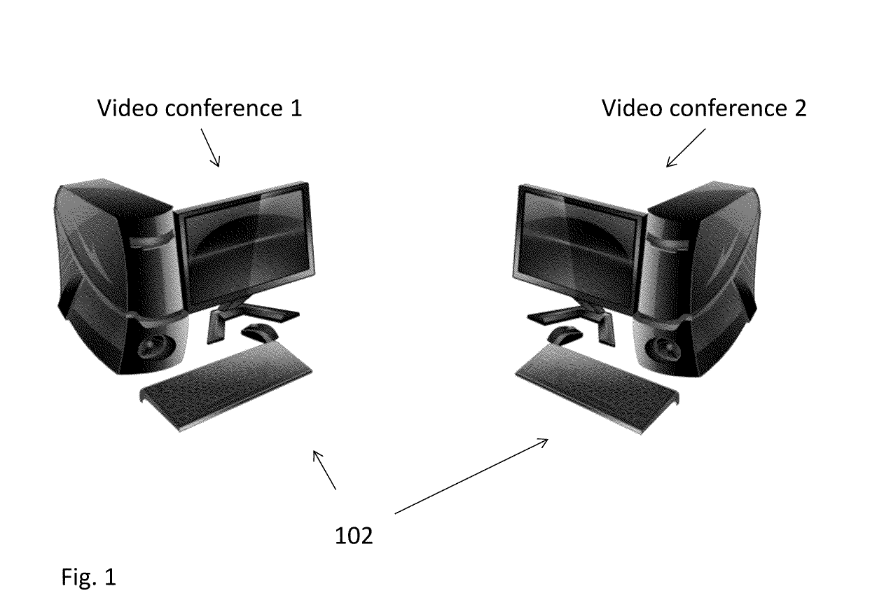

Embodiment 300 includes a set of common computer control equipment 308 (keyboard, mouse, track pad, etc.), and preferably only a single set. As noted above, the technician can elect to interact with one of the video conferences. The common control equipment 308 will control the computer 302 that supports the particular video conference that the technician elects to interact with; for election of video conference VC1 in FIG. 1, common control equipment would control computer 302a, but not 302b or c.

Embodiment 300 includes a common microphone and speaker, preferably in the form of an integrated headset 312. Headset 312 allows the technician to hear the audio feed from all of the video conferences, and to speak into all conferences, or to hear/speak with respect to an elected conference. In particular, a technician can hear all conferences and speak only to a selected one; this allows a technician to address issues in a particular conference while still monitoring the audio feed for the other conferences. The technician can also control the audio from the conferences, such as changing the volume or muting certain conferences. Although shown in FIG. 3 as an integral component, separate speaker/headphones and microphones could be used.

Embodiment 300 also includes at least one camera 310 for the technician to participate in the video conference. A camera video feed is preferably provided to each of the computers 302, such that one camera 312 with a splitter and/or multiple cameras 312 (one for each computer 302) can be used.

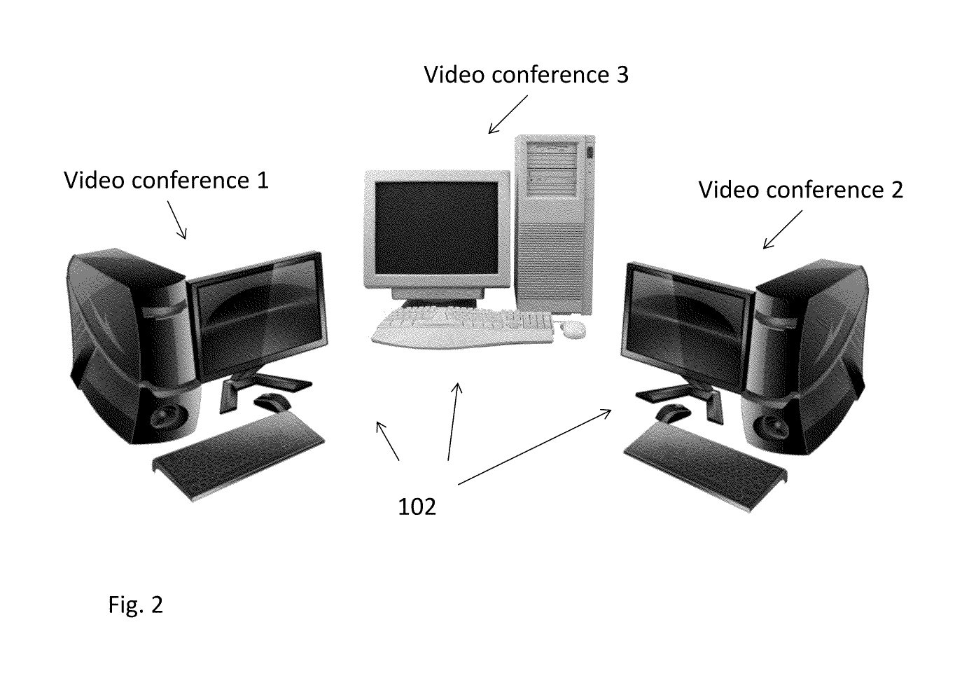

As can be seen in FIG. 3, the technician can monitor multiple conferences from a single physical workspace and a single set of control equipment. Since the technician will not need to physically relocate from one workstation to the next as in FIGS. 1 and 2, the technician will be able to monitor more than two simultaneous video conferences. As a practical matter, given the attention needed for any particular teleconference, Applicants believe that a technician using the embodiment of FIG. 3 will be able to monitor four video conferences, at least a two-fold improvement over the prior art.

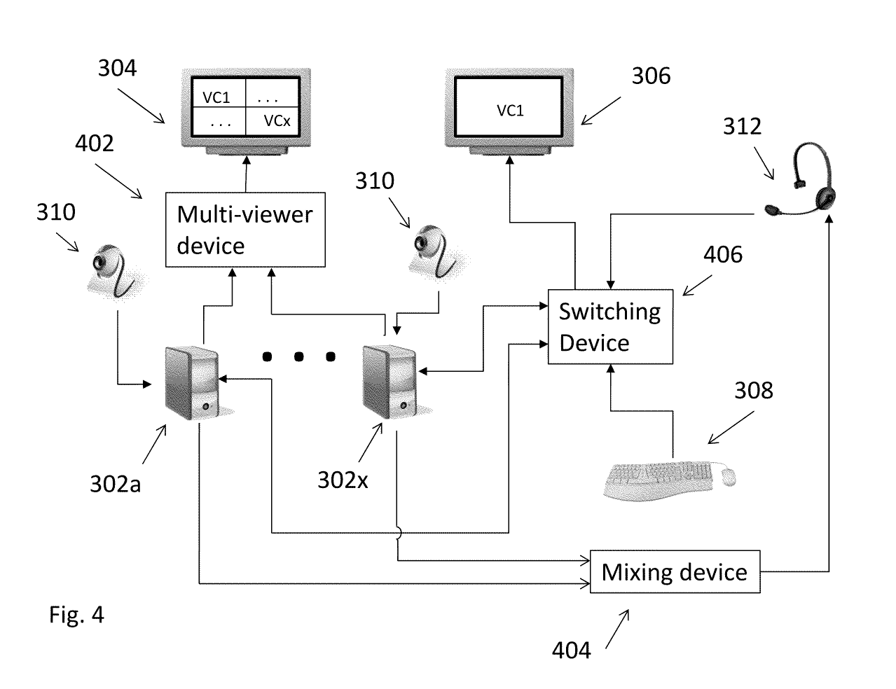

Referring now to FIG. 4, embodiment 300 is shown with the supporting connections and components, in which like numerals represented like components. For ease of discussion, only two computers 302a and 302x are shown to support two video conferences VC1 and VCx, although it is to be understood from the ellipsis (“ . . . ”) that other computers 302 may be similarly present and connected for additional video conferences.

A video output (not separately numbered) of each computer 302 connects to an input of multi-viewer device 402; an output of multi-viewer device 402 connects to video input of monitor 304. The first video output may be in any format known for outputting video from computers, such as HDMI, USB, VGA, etc. It may be desirable for intervening equipment to process the video outputs, such as converting the video signals from one format to another (e.g., HDMI to composite).

Each computer 302 receives a camera signal at a video input from a camera 310. FIG. 4 shows one camera 310 per computer 302, but as noted above this need not be the case. Preferably camera(s) 310 will be positioned so as to all be facing the technician sitting at the workstation.

An audio output (not separately numbered) of each computer 302 connects to an audio input of a mixing device 404; an output of mixing device 404 connects to the headphone portion of headset 312. The audio output may be in any form known for outputting audio from computers.

In a typical computer setup for a video conference, each computer would have its own monitor, microphone and control equipment. In FIG. 4, selectable switching device 406 provides each computer 302 with selected access to monitor 306, control equipment 308 and the microphone of headset 312. The computer 302 as selected by switching device 406 will thus have access to the monitor 306, control equipment 308 and the microphone of headset 312, while the other computers 302 that are not selected will not have such access.

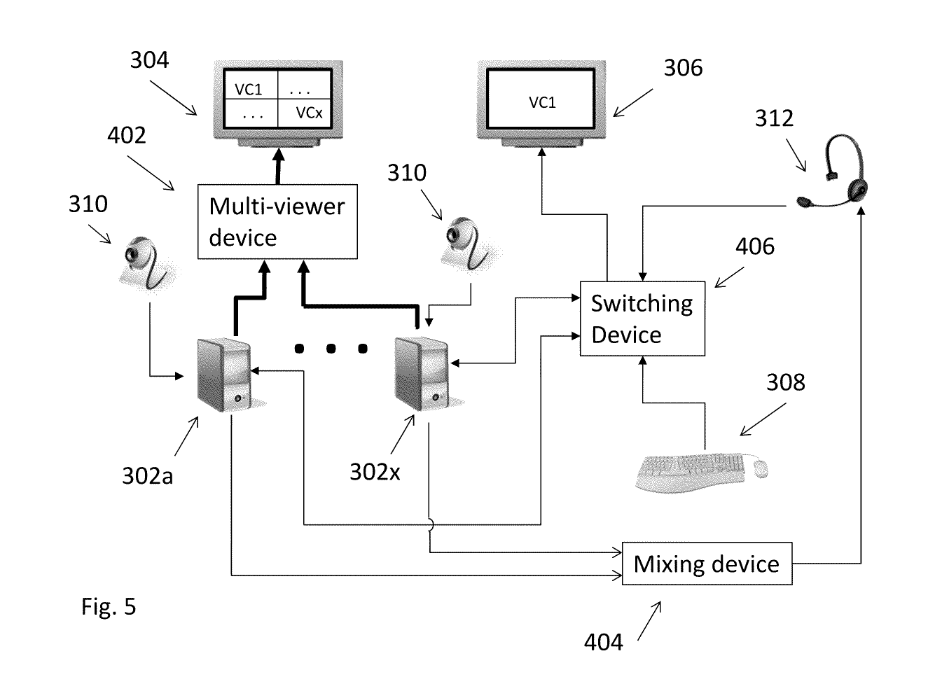

Operation of the above design will now be discussed with reference to FIGS. 5-11.

Initially, the technician would be assigned a particular number of video conferences to monitor. The technician would then join each of the conferences as participant in whatever manner as called for by the video conference provider. The technician would join each conference on a different one of computers 302. The interface methodology for doing so is discussed in more detail below.

A primary function of the technician is to observe all of the assigned conferences. Such observation includes simultaneously monitoring the video feeds and the audio feeds of the assigned video conferences.

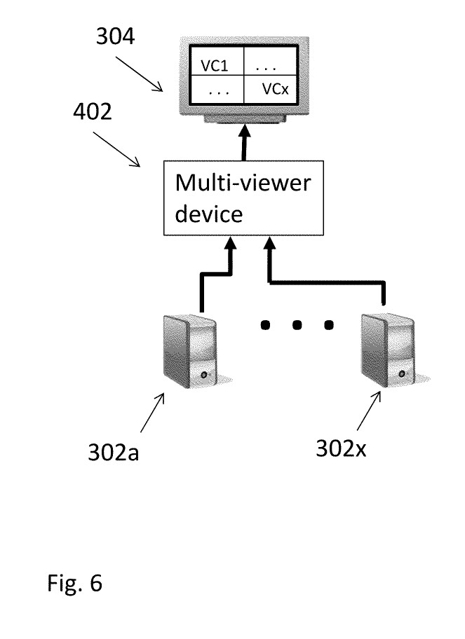

With respect to monitoring the video, reference is made to FIGS. 5 and 6. FIG. 5 shows the architecture of FIG. 4, although certain pathways have been made thicker to highlight the components under discussion, and specifically the components for combining the video feeds.

As noted above, a video output (not separately numbered) of each computer 302 connects to an input of multi-viewer device 402; an output of multi-viewer device 402 connects to a video input (not separately numbered) of monitor 304. The relationship is shown in FIG. 6, which corresponds to FIG. 5 with non-involved components removed.

Multi-viewer device 402 has the function of combining multiple video or computer sources onto a single display, typically by creating a new video feed that includes content from each of the individual received video feeds from computers 302. FIG. 4 shows a video feed of 4 quadrants on monitor 304, where individual quadrants show the video feed of a particular computer 302 (and thus the video of that conference), but the invention is not limited to any particular number or layout.

A non-limiting example of a multi-viewer device 402 is known in the video industry as a multiplexer, such as LTC 2382/90 by BOSCH or VM-Q401A by CCTV CAMERA PROS. The structure and operation of such a commercial device is known by those of skill in the art in the industry and is not further described herein. However, the invention is not so limited, and any device that performs the described functionality may be used. For example, a general purpose computer as programmed to combine the video could be used.

The above methodology provides one visual area where all of the video feeds are available for simultaneous monitoring. There is no need for a technician to move their head back and forth to observe different monitors for different conferences.

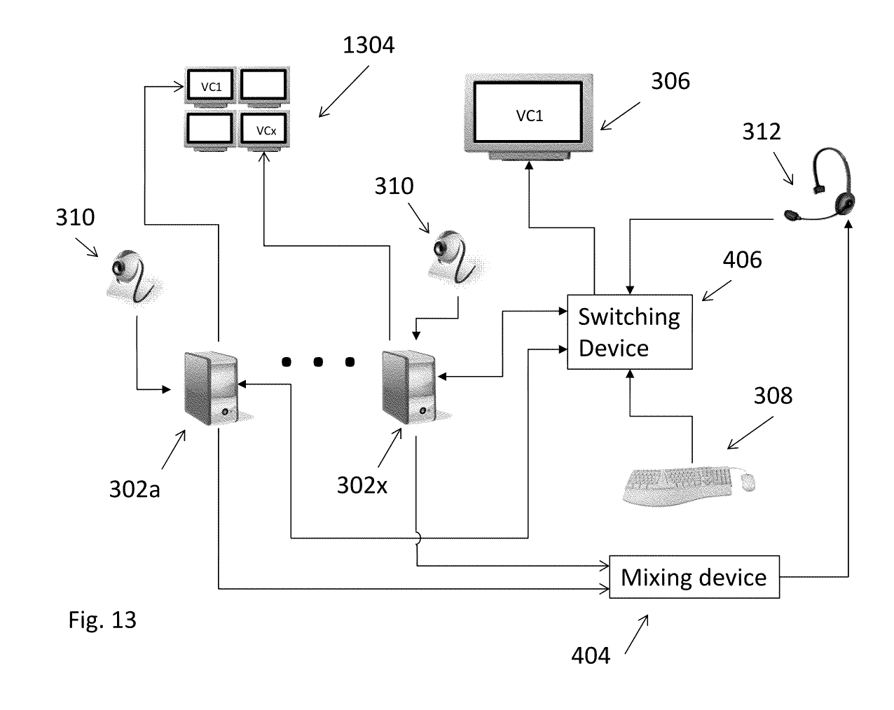

Referring now to FIG. 13, as an alternative embodiment is shown in which the individual computers 302 provide their video feeds individually to multiple monitors 1304 without need of a multiviewer. The monitors 1304 collectively form a mosaic in the collective viewing area. As a further alternative, multiple screens may be used, with one or more supported by multi-viewer devices; this may be of value if there is a minimum preferred video size and the number of monitored conferences would exceed the size of a single monitor. By way of non-limiting example, if the minimum size was four video conferences per screen and five conferences were being monitored then more than one monitor would be needed. Preferably two monitors would be used, with both connecting to multi-viewer device(s). In the alternative, one monitor could hand one conference while the other handles four through a multi-viewer device.

Preferably the various monitors 304/1304 and 306 are sized and positioned so that the technician has a single common viewing field where the technician can simultaneously see all the video feeds without having to turn their head or move to different workstation positions.

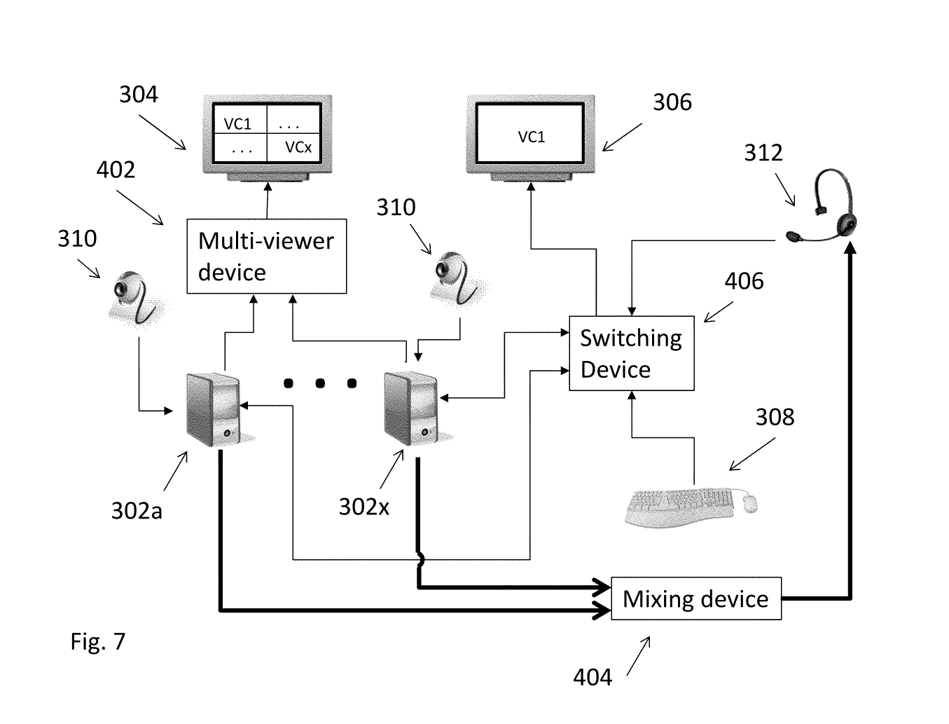

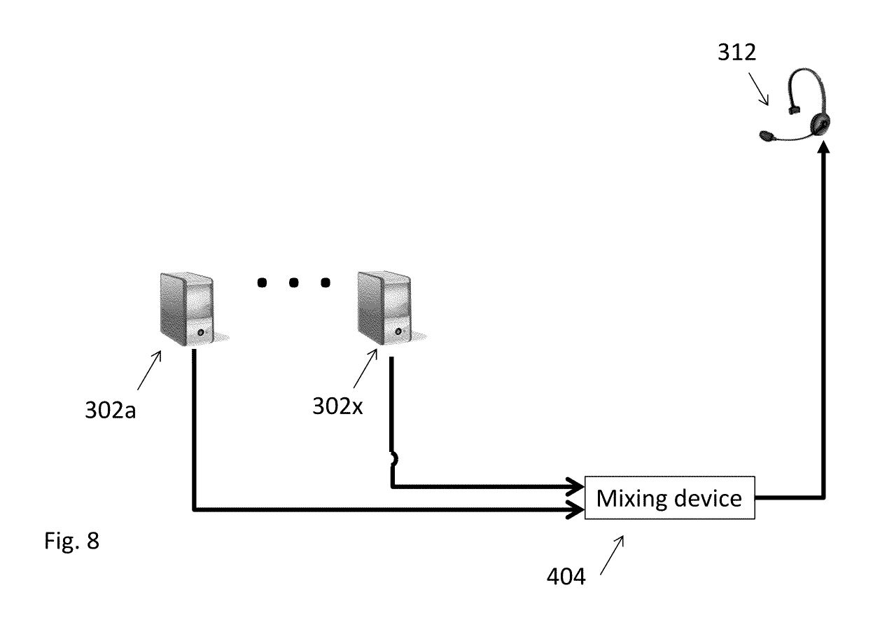

With respect to the monitoring the audio, reference is made to FIGS. 7 and 8. FIG. 7 shows the architecture of FIG. 4, although certain pathways have been made thicker to highlight the components under discussion, and specifically the components for combining audio feeds.

Each computer 302 has an audio output (not separately labeled) that connects to audio mixing device 404. Mixing device 404 thus receives audio signals for the remote participants in each of the video conferences VC1-VCx. Using known techniques, mixing device 404 combines the audio signals into one common signal that includes audio for remote participants of all video conferences; the mixing device 404 may add them equally or unequally as desired for best balance of the audio; the technician may also suppress various audio to isolate one or more. This common audio signal is output to the speaker within headset 312. The mixing device 404 may optionally apply various processing to the signals, such as filtering, balancing, etc. The relationship is shown in FIG. 8, which corresponds to FIG. 7 with non-involved components removed.

A non-limiting example of a mixing device 404 is known in the audio industry as a mixer, such as XENYX 1202 by BEHRINGER. The structure and operation of such a commercial device are known by those of skill in the art in the industry, and is not further described herein. However, the invention is not so limited, and any device that performs that functionality may be used. For example, a general purpose computer as programmed to combine the audio could be used.

The above methodology provides one speaker, preferably in headset 312, where all of the audio feeds are available for simultaneous monitoring by the technician.

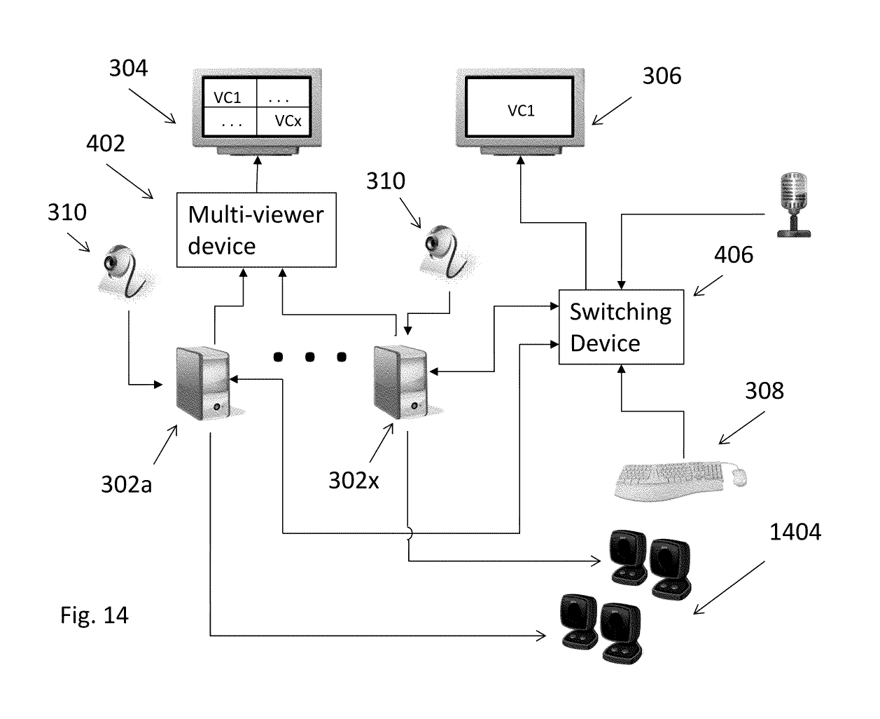

Referring now to FIG. 14, as an alternative embodiment is shown in which individual computers 302 provide their audio feeds individually to multiple speakers 1414. The combined sound output of the speakers 1414 includes the audio of the remote participants to the various conferences. A microphone 316 is separately provided.

The video and audio steps above allow a single technician, using a single workstation, to passively observe the audio and video of several different video conferences.

Another primary function of the technician is to actively participate in a particular video conference as needed. For example, the technician needs to join each conference, may participate in opening the conference and confirming all is set, and/or responding to a request made by a participant for technical assistance.

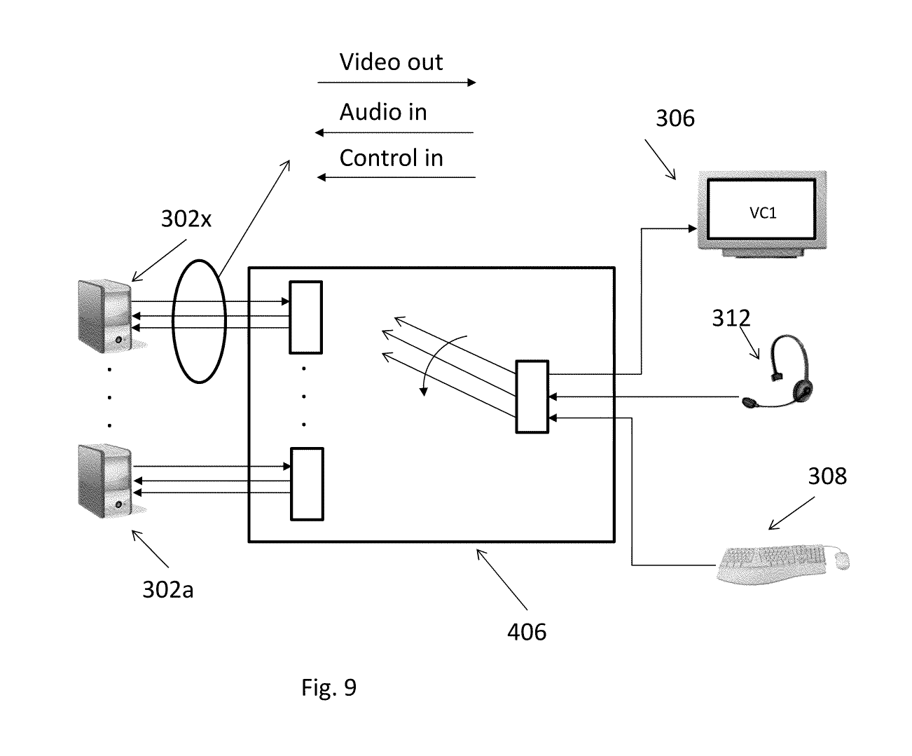

A supporting component of active participation is switching device 406. Referring now to FIG. 9, the functionality of switching device 406 is shown. Switching device 406 effectively acts as a single pole multi-throw switching element. The single pole connects to the pathways for monitor 306, control equipment 308 and microphone of headset 312. The various other ends selectively connect to the video out, control in, and sound in pathways of each computer 302; although these are shown as separate pathways, it is to be understood that the pathways may be common/shared and/or separate from each other, and that more or less pathways may be needed. The arrows of the pathways are exemplary only and not intended to limit the invention.

A non-limiting example of a switching device 404 is known in the computer industry as a KVM switch, such as 4SVPUA20-001 by AVOCENT. The structure and operation of such a commercial device is known by those of skill in the art in the industry, and is not further described herein. However, the invention is not so limited, and any device that performs that functionality may be used. For example, a general purpose computer as programmed to switch between the computers 302 could be used.

The technician selects via the switching device 406 to connect the particular computer 302 that supports the video conference that the technician wants to actively participate in. For example, if the technician wants to participant in video conference VC1, then he selects computer 302a on switching device 406. Participation will then be with video conference VC1 because monitor 306 and the microphone of headset 312 will be connect to the supporting computer 302a.

By virtue of the connection to a particular computer, the other computers that are not selected are disconnected from monitor 306, control equipment 308 and microphone of headset 312. The technician therefore cannot participate in the other video conferences that those computers 302 support unless the technician makes a new selection.

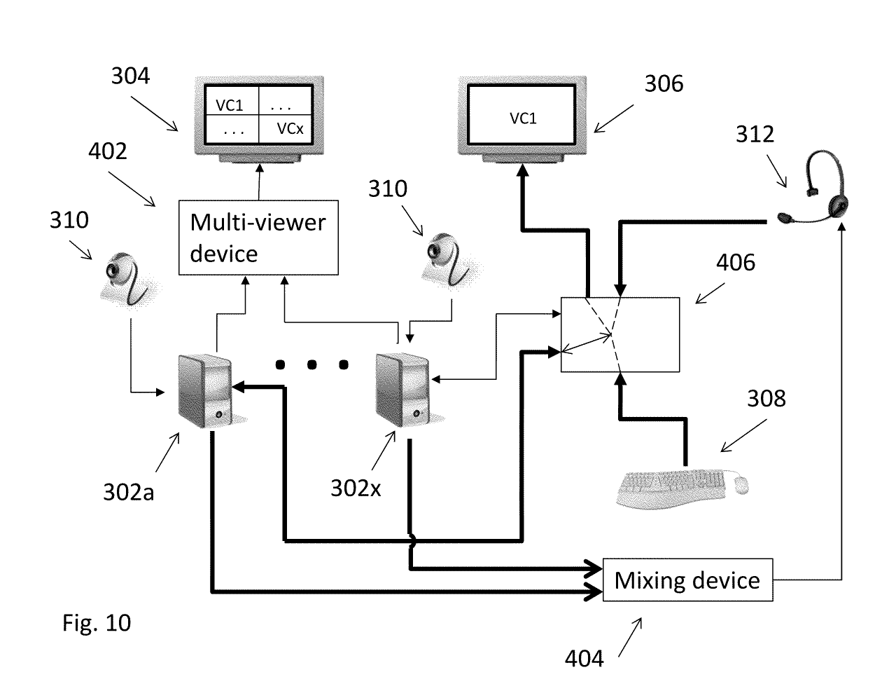

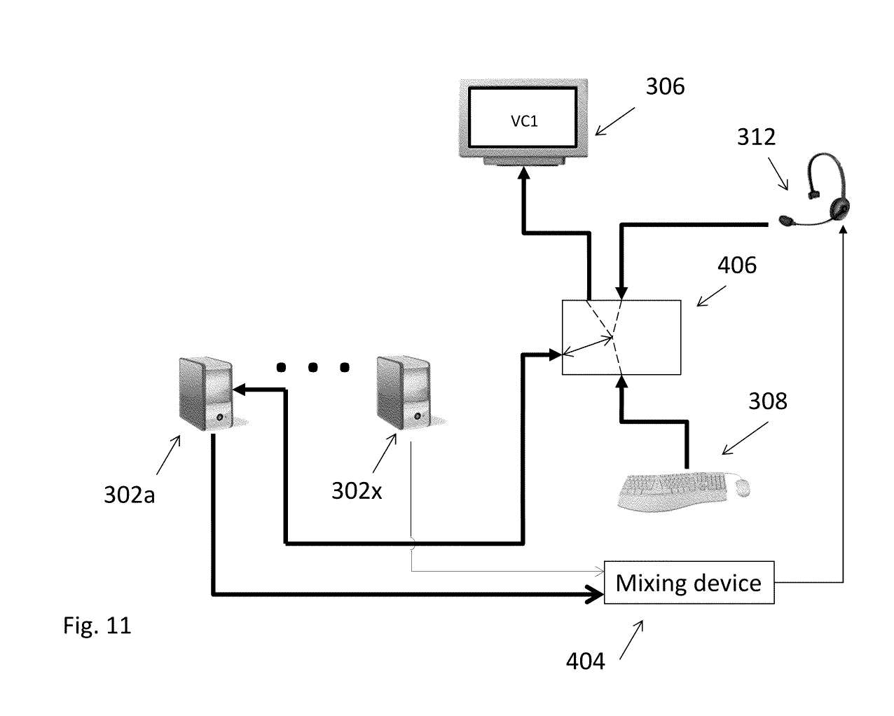

With respect to system activity post-selection, reference is made to FIGS. 10 and 11. FIG. 10 shows the architecture of FIG. 4, although certain pathways have been made thicker to highlight the components under discussion.

In FIG. 10, the technician selects computer 302a to participate in video conference VC1. Computer 302a is connected to the noted components, and the other computers (e.g., 302x) are disconnected. The video feed of the selected video conference VC1 appears on the monitor 306. Audio from microphone of headset 312 is heard in video conference VC1, but not in other video conferences (e.g., VCx). If there is a technical matter that requires IT support, the technician can interact with computer 302a via the control equipment 308 without affecting the status of the other video conferences. The relationship is shown in FIG. 11, which corresponds to FIG. 10 with non-involved components removed.

The technician can change video conferences simply by changing the selection on switching device 406. For example, if computer 302x is selected, computer 302x is controlled, received audio from the microphone, and displays video conference VCx on monitor 306.

In the embodiments above, while the audio input to computers 302 from the microphone of headset 312 is subject to the switching of switching device 406, preferably the audio output of the computers 302 is not. The reason is to maintain the overall monitoring goal of various embodiments. If the audio out was subject to the switching, then the technician could not hear the activity in all of the conferences; the audio out of the computers 302 thus bypasses switching device 406. However, the invention is not so limited, and the audio out of computers 302 could be fed to the switching device; in this case some other cue would be used by the participants to attract the technician's attention.

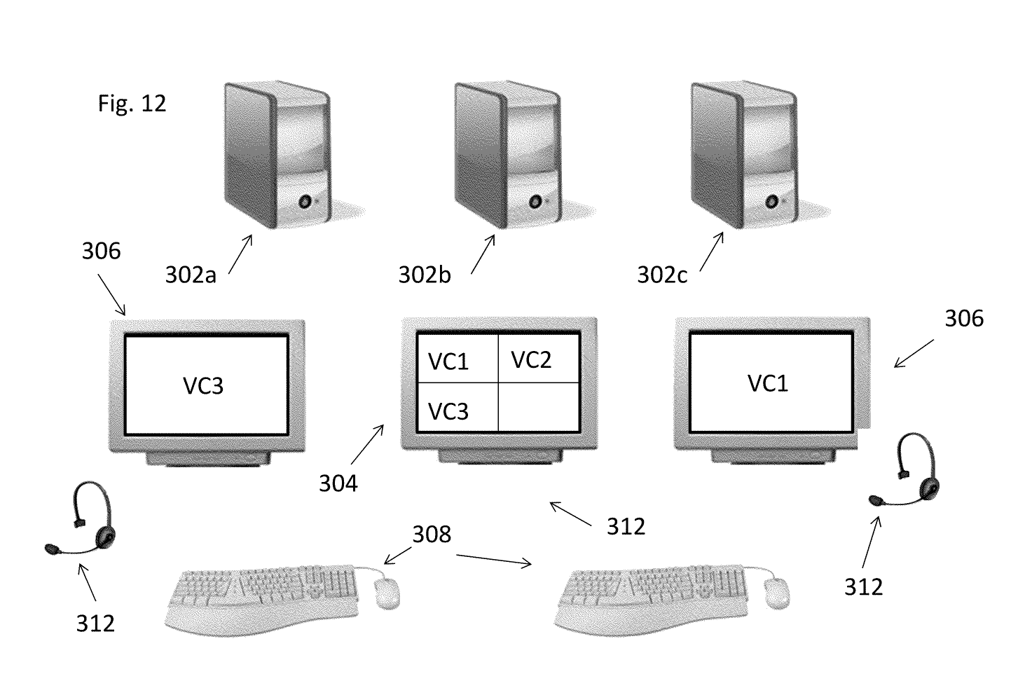

Referring now to FIG. 12, another embodiment of the invention is shown. In this embodiment, multiple sets (two are shown) of switching devices 406, monitors 306, control equipment 308 and headsets 312 are provided. This would allow multiple technicians to monitor the multiple conferences. The underlying connections would mirror those shown in FIG. 4.

The above embodiment provides a degree of redundancy. For example, suppose two technicians are each monitoring four different conferences (eight in total between them). One of the technicians is pulled into one of his monitored conferences, and then another under his watch needs assistance. The technician can ask the other technician to intervene in that second conference, even though it was not assigned to that second technician.

A similar redundancy would have several technicians being monitored by a supervisor or backup technician. For example, the backup could be assigned to four technicians, and thus monitor sixteen different conferences. This higher number is possible because the backup is monitoring the technicians rather than the individual conferences. If a particular technician is called to participate in a video conference, the backup can monitor the remainder of the technician's video conferences. The underlying setups would be the same as in FIG. 4, although additional switching may be needed to isolate the conferences for particular technicians. Additional monitors may be needed; for example, one monitor to show a mosaic of all conferences under backup, another for the selected technician's video conferences, and another for a particular video conference.

Each individual computer 302 may have its own individual display and set of control equipment as a backup or to allow assistance from another technician if the main technician is occupied.

The embodiment of FIG. 4 has an additional advantage in that all of the components may be “off the shelf” components, including a multiplexer, mixer and KVM switch. No specialized computer skills or engineering skills are necessary to purchase and connect the components. No custom components are necessary. No software changes need to be made to the video conferencing software, nor does new software need to be designed.

According to another embodiment of the invention, the various components and connections could be incorporated into one or more off the shelf or custom housings. By way of non-limiting example, a single component could include, or perform the functions of, multi-viewer device 402, mixing device 404 and/or switching device 406. There may be an analog hardware implementation consistent with the components as discussed herein, or a software/hardware combination.

The various connections herein may be direct or indirect. By way of non-limiting example, computer 302a may be connected directly to mixing device 250 directly as shown in FIG. 4. However such connection may be through an intermediate component.

Further, minor variations in the signals induced by any such indirect components (e.g., power levels, minor distortions, filtering) that do not significantly affect the substantive content of the signals. By way of non-limiting example, computer 302a can be considered to feed the audio signal mixer device 404. However, placing a filter there between (e.g., to remove background static or sounds from frequencies outside of spoken language) may slightly alter the audio signal such that the signal as fed from computer 302a is not exactly the signal received at mixing device 404. For purposes of the application, since the substantive content is not substantively affected, this is still considered to feed the signal from computer 302 to mixing device 404, notwithstanding the intervening component and the minor change that the filter created.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A method for monitoring a plurality of video conferences, the method employing at least first and second monitors, a speaker, a microphone, and a plurality of computers, the method comprising:
(a) joining each of the plurality of video conferences on a different one of the plurality of computers;
(b) providing a monitoring environment of all of the plurality of video conferences, comprising:
(1) first displaying, simultaneously in a mosaic using at least the first monitor, video feed from the plurality of computers;
(2) outputting a combined audio feed of the plurality of computers; (c) interacting with one of the plurality of video conferences, comprising:
(1) selecting one of the plurality of computers for connection to at least the microphone and the second monitor,
(2) sending an audio feed from the microphone to the selected one of the plurality of computers;
(3) second displaying, on the second monitor, a video feed of the video conference as provided by the selected one of the plurality computers;
(d) wherein the method is configured to perform the monitoring and the interacting at the same time, such that all video conferences can be monitored while one of the video conferences is interacted with.

2. The method of claim 1, wherein the first displaying comprises:
receiving individual video feed of each of the plurality of computers;
generating, from the received individual video feeds, a single video signal representing a mosaic of the received individual video feeds; and
displaying the single video signal.

3. The method of claim 2, wherein the generating comprises processing by a multi-viewer device.

4. The method of claim 1, wherein outputting the combined audio feed comprises:
receiving the audio of the plurality of conferences; and
combining the audio of the plurality of conferences into the combined audio feed.

5. The method of claim 4, wherein the receiving and combining are performed by a mixing device.

6. The method of claim 1, wherein the selecting prevents the non-selected ones of the plurality of computers from interacting with the microphone and second monitor.

7. The method of claim 1, wherein the selecting is performed by a switching device, the switching device connecting the microphone and second monitor to a plurality of selectable paths to the plurality of computers; the selecting further comprising:
selecting one of the plurality of paths;
wherein the switching device connects the selected one of the plurality of computers to the microphone and second monitor; and
wherein the switching device disconnects the non-selected ones of the plurality of computers from the microphone and second monitor.

8. The method of claim 1, wherein the selecting:
permits, through the speaker and the second monitor, participation in the video conference supported by the selecting one of the plurality of computers; and
precludes participation in the non-selected video conferences.

9. The method of claim 1, further comprising control equipment, wherein the selecting comprises selecting one of the plurality of computers for connection to the control equipment.

10. A method for monitoring a plurality of video conferences, comprising
maintaining a plurality of video conferences;
first displaying, in a common viewing area, a mosaic of video feed of plurality of video conferences;
outputting an audio feed of the plurality of video conferences;
selecting an individual one of the plurality of video conferences;
second displaying, in a separate area from the first displaying, video feed of the selected video conference; and
receiving audio input for the selected video conference to the exclusion of non-selected video conferences;
wherein the first displaying and outputting allow passive monitoring of plurality of video conferences, and the second playing and receiving allow active interaction with the selected video conference.

11. The method of claim 10, further comprising:
receiving control commands for the selected video conference to the exclusion of the non-selected video conferences.

12. The method of claim 10, wherein the method is configured to simultaneously perform the maintaining, first displaying, outputting, second displaying, and receiving.

13. The method of claim 10, further comprising changing to a different selected video conference, wherein in response thereto the second displaying and the receiving transition to the different selected video conference.

14. The method of claim 10, wherein the selecting is performed by a switching device that selectively connects a monitor and a microphone to a computer that supports the selected video conference, the monitor supporting the second displaying and the microphone supporting the receiving.

15. The method of claim 10, wherein the selecting:
permits active participation in the selected video conference; and
precludes active participation in the non-selected video conferences.

16. The method of claim 10, wherein the selecting does not affect the outputting.

17. A video conference monitoring apparatus, comprising:
a plurality of computers, each supporting an independent video conference;
an audio mixing device connected to the plurality of computers and configured to combine audio feed of the plurality of computers into a combined audio feed;
a multi-viewer device connected to the plurality of computers and configured to combine the video feed of the plurality of computers into a mosaic on a first monitor;
a microphone configured to send audio;
a second monitor;
a switching device configured to selectively connect the microphone and the second monitor to a selected one of the plurality of computers;
wherein the video conferences are configured to be passively monitored by the mosaic on the first monitor and the combined audio feed;
wherein a selected video conference can be actively participated in by setting the switching device to the computer that supports the selected video conference.

18. The apparatus of claim 17, wherein the switching device is a KVM switch.

19. The apparatus of claim 17, wherein audio feed from the microphone passes through the switching device and is subject to its selection, and the audio feed from the plurality of computers bypasses the switching device and is not affected by the switching device.
